(19) United States
(12) Patent Application Publication
(10) Pub. No.: US 2026/0004593 A1
(43) Pub. Date: Jan. 1, 2026

(54) END-TO-END TRANSFORMER-BASED BOUNDING BOX TRACKING

(71) Applicant: Motional AD LLC, Boston, MA (US)

(72) Inventors: Lubing Zhou, Singapore (SG); Xiaoli Meng, Singapore (SG)

(21) Appl. No.: 19/319,242

(22) Filed: Sep. 4, 2025

Related U.S. Application Data
(63) Continuation of application No. PCT/US2024/018822, filed on Mar. 7, 2024.
(60) Provisional application No. 63/489,061, filed on Mar. 8, 2023.

(51) Int. Cl. G06V 20/56; G06T 7/20; G06V 10/25; G06V 10/764

(52) U.S. Cl. CPC G06V 20/56; G06T 7/20; G06V 10/25; G06V 10/764

(57) ABSTRACT

A perception system may be used to generate bounding boxes for objects in a vehicle scene. The perception system may receive images and feature maps corresponding to the received images. The perception system may link bounding boxes to bounding boxes from a previous time steps and identify false positive bounding boxes. The system can link 3D boxes of the same object from the different frames, by taking the 3D boxes in a time step as input. The system can sue transformer self-attention to exchange information between 3D boxes to learn global-informative box embeddings. Similarity between these learned embeddings can be used to link the boxes of the same object.

### INCORPORATION BY REFERENCE TO ANY PRIORITY APPLICATIONS

This application is a continuation of International Patent Application No. PCT/US2024/018822, filed on Mar. 7, 2024 entitled “END-TO-END TRANSFORMER-BASED BOUNDING BOX TRACKING” which claims the priority benefit of U.S. Patent Prov. App. 63/489,061 entitled “END-TO-END TRANSFORMER-BASED BOUNDING BOX TRACKING, filed Mar. 8, 2023. Each of the above-noted applications is incorporated herein by reference in its entirety.

### BACKGROUND

Self-driving vehicles may track bounding boxes generated for objects in a vehicle scene using images obtained from one or more image sensors.

### BRIEF DESCRIPTION OF THE FIGURES

FIG. 1 is an example environment in which a vehicle including one or more components of an autonomous system can be implemented.

FIG. 2 is a diagram of one or more systems of a vehicle including an autonomous system.

FIG. 3 is a diagram of components of one or more devices and/or one or more systems of FIGS. 1 and 2.

FIG. 4A is a diagram of certain components of an autonomous system.

FIG. 4B is a diagram of an implementation of a neural network.

FIGS. 4C and 4D are a diagram illustrating example operation of a CNN.

FIG. 5 is a block diagram illustrating an example perception environment in which the perception system receives and processes images to provide one or more (3D) bounding boxes for objects in a vehicle scene.

FIG. 6A is an example of a portion of a vehicle scene with bounding boxes generated for objects in the vehicle scene.

FIG. 6B illustrates a simplified example of a time series of bounding boxes generated based on image data at different time steps.

FIG. 7 is a data flow diagram illustrating an example perception environment in which a perception system generates tracking data associated with each bounding box.

FIGS. 8A-8B illustrate examples bounding boxes generated in subsequent time-steps based on image data at the bounding box tracking stage.

FIG. 9 is a flow diagram illustrating an example of a routine 900 implemented by at least one processor to generate bounding box linking scores and object scores during operation of an autonomous vehicle.

FIG. 10 is a flow diagram illustrating an example of a routine 1000 implemented by at least one processor to navigate a vehicle based on bounding box tracking of at least one bounding box generated from one or more lidar point clouds or images.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. Also, the term “or” is used in its inclusive sense (and not in its exclusive sense) so that when used, for example, to connect a list of elements, the term “or” means one, some, or all of the elements in the list. Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. As used herein, the term “if” is, optionally, construed to mean “when,” “upon,” “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has,” “have,” “having,” or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### Overview

To effectively navigate through various scenes, autonomous vehicles use a perception system such as lidar or image detectors to identify objects in a scene and then navigate the scene based on the identified objects. As part of the navigation process, the autonomous vehicles may draw (3D) bounding boxes around objects in lidar point clouds or images to understand the spatial relationship of the object to the autonomous vehicle. The autonomous vehicle can track the objects from scene to scene using object identifiers for each detected bounding box.

It can be challenging to accurately track 3D bounding boxes on objects in a real-time driving environment from scene to scene. In some cases, this difficulty can be based on issues such as, movement of objects, movement of the vehicle, erroneous object detection, proximity of other objects, or types of objects, among others. Moreover, individual lidar or cameras on an autonomous vehicle may not capture an entire object increasing the difficulty of identifying objects in a vehicle scene.

To address these issues, Kalman-filter based trackers can be used to track 3D bounding boxes. Machine learning methods, such as transformers, have proved to be powerful to detect bounding boxes during operation of an autonomous vehicle. For example, the use of self-attention by a transformer to learn bounding box features with spatial context information from all the 3D boxes across a time window, such as, for example, 32 frames. The use of a transformer can boost the tracking performance comparing with frame-to-frame propagations in classic tracking methods.

In the present disclosure, the system is configured to use object queries to generate 3D bounding boxes for objects within a lidar scene at a defined time step. The system can use the bounding boxes within the time step, for example 32 frames, as input for a bounding box tracking function. For each bounding box, the system can use machine learning encoder, such as a multilayer perceptron (MLP), to generate a bounding box embedding based on the bounding box features.

The bounding box embedding can be input into a series of transformer layers to enrich the bounding box embedding. The transformer layers can include a self-attention and feed forward stages to enrich the bounding box embedding. The output of the transformer is an enriched bounding box embedding for each bounding box.

The enriched bounding box embeddings can be used to link the bounding boxes to bounding boxes from a previous time step and identify false positive bounding boxes. The enriched bounding box embeddings can be used to generate linking scores, used to link the bounding boxes, and object scores, used to determine whether the bounding box is a false positive. The linking scores can be used to link a bounding box from a previous time step to a bounding box of the present time step in order to form a track. Object scores for each bounding box can be used to determine whether each bounding box is a false positive box.

### General Overview

By virtue of the implementation of systems, methods, and computer program products described herein, an autonomous vehicle can more accurately identify objects within an image, more accurately identify the location of identified objects within the image, more accurately predict trajectories of identified objects within the image, determine additional features for identified objects, and infer additional information about the scene of an image.

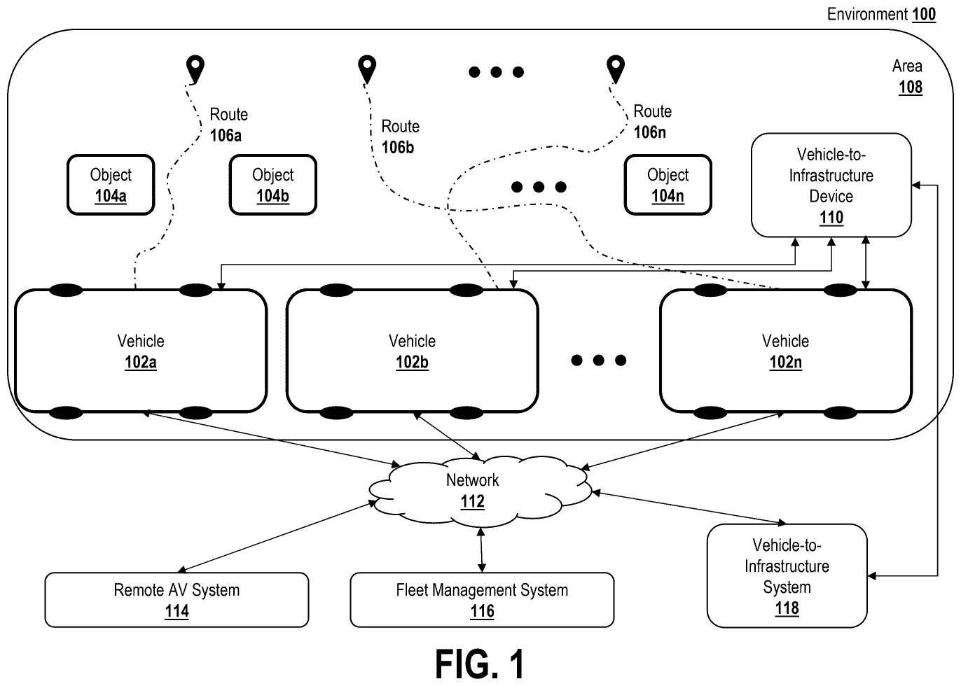

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

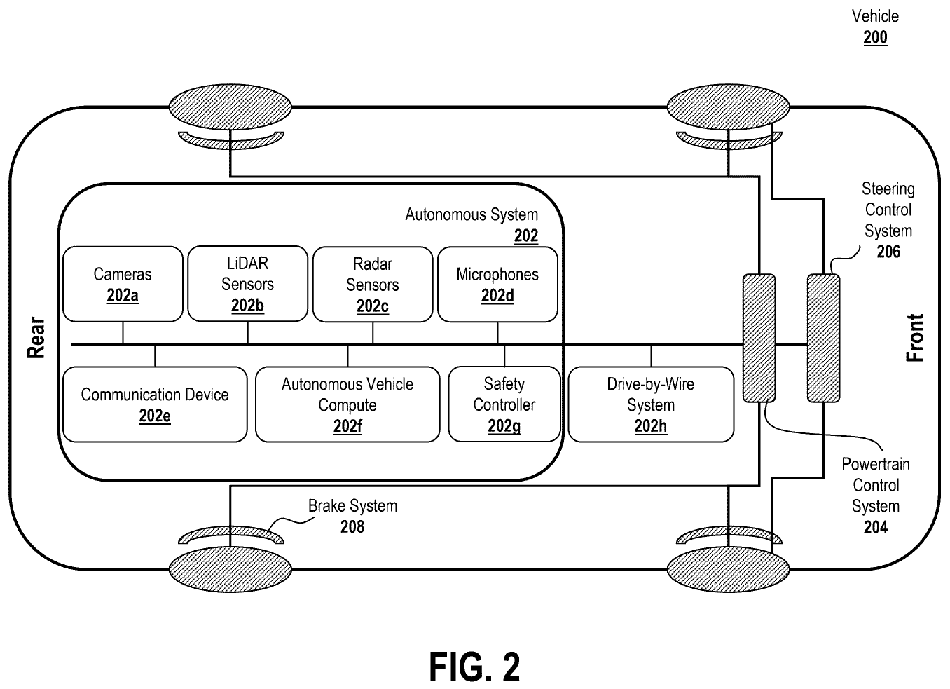

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g., a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high-level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high-level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

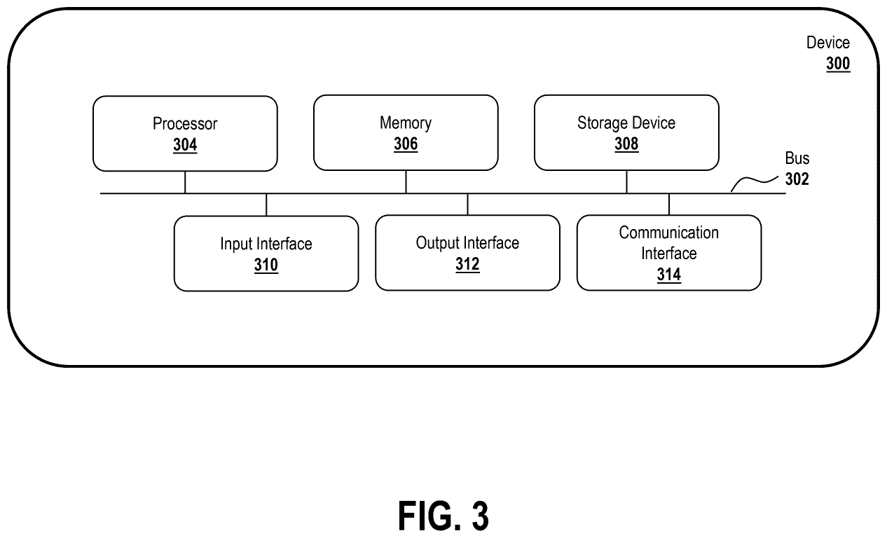

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid-state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally, or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 306 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally, or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally, or alternatively, a set of components (e.g., one or more components) of device 300 can perform one or more functions described as being performed by another component or another set of components of device 300.

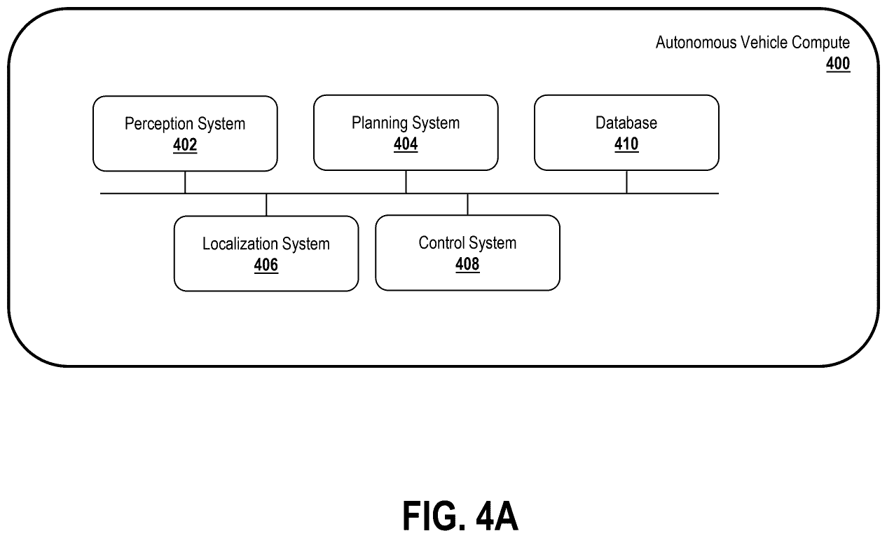

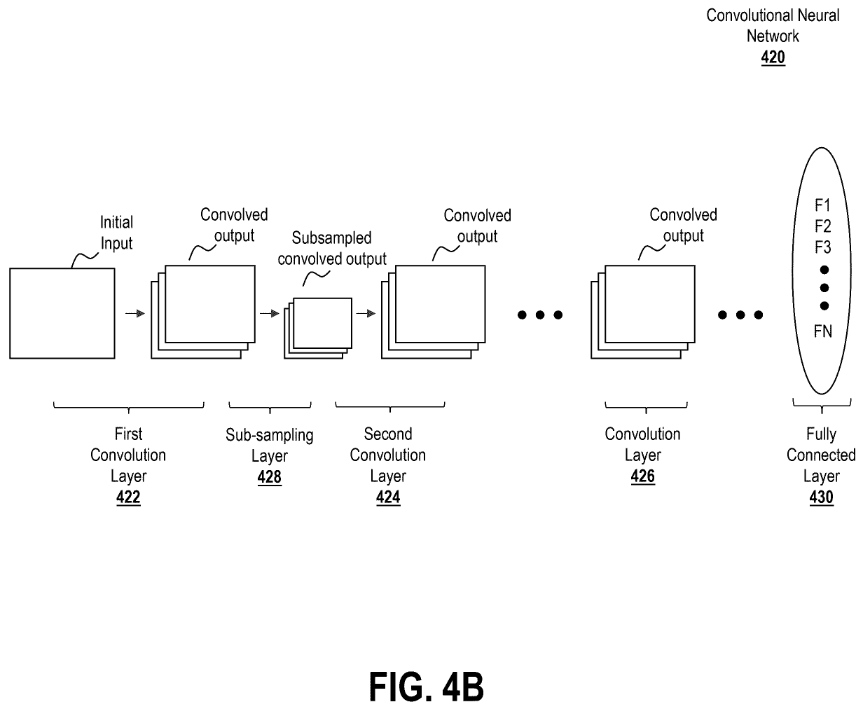

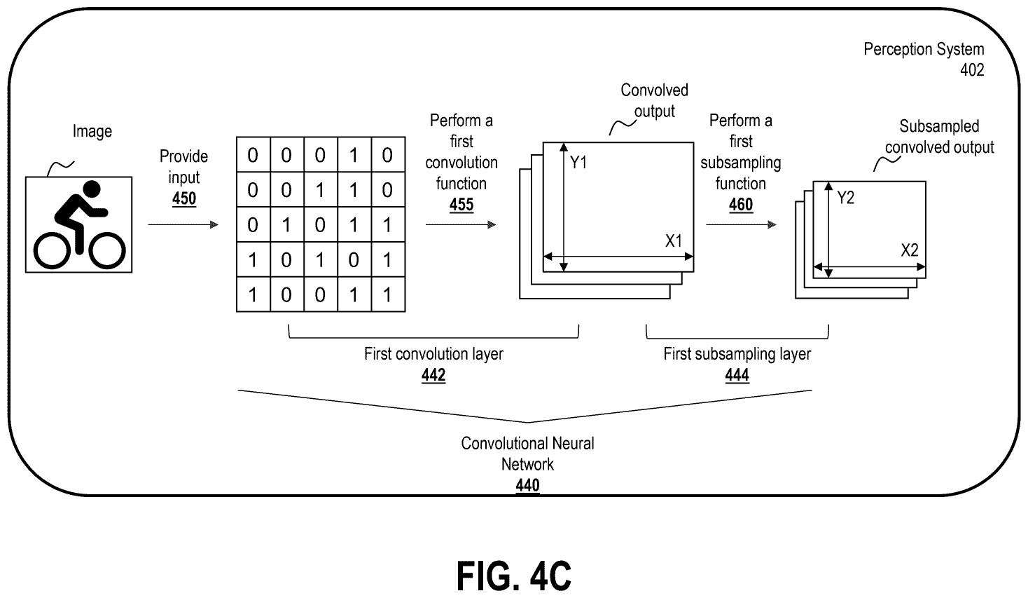

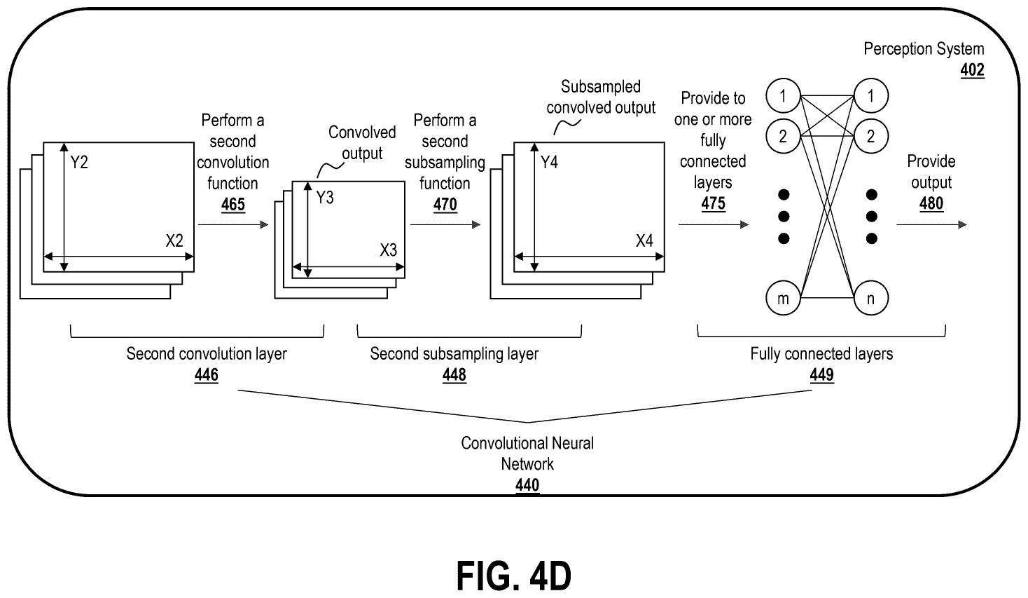

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial Input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., camera data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

### Generating Bounding Boxes for Navigation

As described herein, to improve the functionality of an autonomous vehicle and its ability to generate bounding boxes and navigate environments in real-time, an autonomous vehicle may be configured to use feature maps and object queries to combine or relate features within the input images. In certain cases, the multiple feature maps are cross correlated with each other and the object queries.

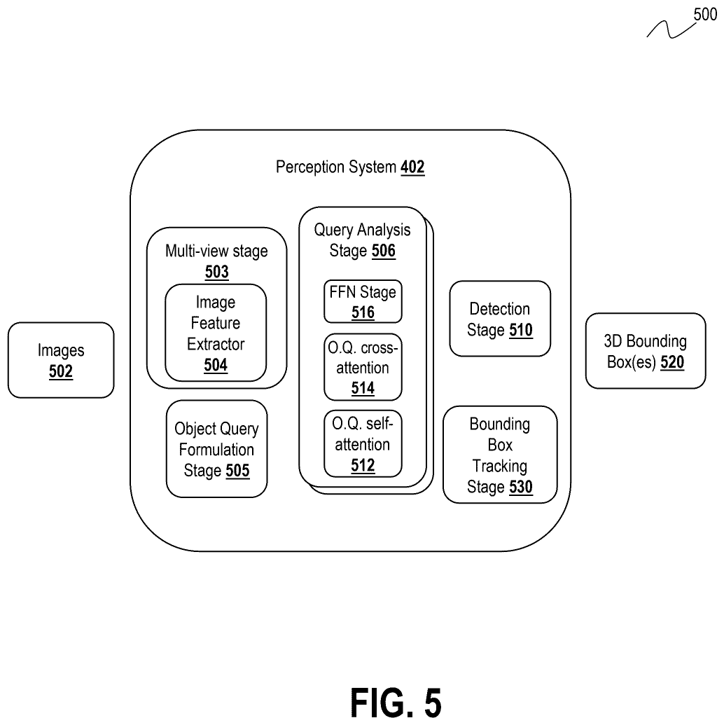

FIG. 5 is a block diagram illustrating an example perception environment 500 in which the perception system 402 receives and processes images 502 to provide one or more (3D) bounding boxes 520 for objects in a vehicle scene (corresponding to the images 502). In the illustrated example, the perception system 402 includes an image feature extractor 504, an object query formulation stage 505, a query analysis stage 506, a detection stage 510, and a bounding box tracking stage 530. However, it will be understood that the perception system may include fewer or more components. In some cases, the perception system 402 may omit the object query formulation stage 505. For example, in some cases, the query analysis stage 506 may output one or more object queries and may have predetermined queries and may not formulate new object queries. The various components of the perception system 402 described herein may be implemented using one or more processors and/or as one or more layers or stages of a machine learning model or neural network.

The images 502 for a particular scene (also referred to herein as a set of images 502) may include image data from one or more sensors in a sensor suite. The images 502 may include different types of images corresponding to the sensor or device used to generate them. For example, the images 502 may be camera images generated from one or more cameras, such as cameras 202a, or lidar images (e.g., lidar point clouds) generated from one or more lidar sensors, such as lidar sensors 202b. Other image types can be used, such as radar images generated from one or more radar sensors (e.g., generated from radar sensors 202c). Each image may correspond to a different image sensor (or camera) that is placed at a different location around an autonomous vehicle. In some cases, the combination of images can form a 360-degree view of a scene of an autonomous vehicle from the perspective of the autonomous vehicle. As such, each image of the images 502 may be neighbor or border another of the images 502 and some objects (or parts of an object) may show up in different images of the images 502.

Moreover, the images 502 of a set of images may be generated at approximately the same time and may form part of a stream of different images. As such, the images 502 may represent the scene of a vehicle at a particular time, or time step. As the perception system 402 uses the images to generate bounding boxes 520 and navigate a vehicle, it will be understood that the perception system 402 may process the images 502 in real-time or near real-time to generate the bounding boxes 520.

### Multi-View Stage

The image feature extractor 504 may be implemented using one or more neural networks or layers of a neural network to extract features from the images 502. In some cases, the image feature extractor 504 may be implemented using backbones with a feature pyramid network (FPN), residual networks (Resnet), or Swin transformer, CSWin transformer, vision transformer (ViT), etc. The image feature extractor 504 may generate one or more feature maps using the images 502. In some cases, the image feature extractor 504 generates at least one feature map for each of the images 502. For example, if the image feature extractor 504 receives six images corresponding to six cameras placed at different locations around the vehicle and oriented in different ways (e.g., to obtain a 360-degree view of the area around the vehicle), the image feature extractor 504 may generate six feature maps, respectively.

The feature maps may have the same or different shapes from the images used to generate them and/or from each other. For example, if each of the images 502 has the shape [900, 1600, 3], respective feature maps may have the shape [45, 80, 256], however, it will be understood that the feature maps may have different shapes from each other.

Each feature map of the generated feature maps may be divided into an array of grid cells having a particular channel depth. The grid cells may include semantic data (or features) extracted from (pixels in) the image(s) from which the feature map was generated. The features of a grid cell may be organized as a vector or some other tensor shape. For example, the features (or semantic data) of a grid cell may indicate a shape, light, texture, reflectivity, edge, object class, location, etc. of something detected by the image feature extractor 504.

The multi-view stage 503 may enrich feature maps by comparing and/or correlating features from different feature maps. In some cases, the multi-view stage 503 uses the features from grid cells in a group of grid cells to update each other (also referred to herein as self-attention). For example, the multi-view stage 503 may use features of a group of grid cells in one or more feature maps to enrich or modify features of a particular grid cell in the group of grid cells.

In certain cases, the multi-view stage 503 may group grid cells based on objects (e.g., group grid cells that correspond (or appear to correspond) to the same object or to an outline of the same object). In some cases, the multi-view stage 503 may group grid cells by dividing a feature map into multiple regions (also referred to herein as windows) and/or assign different grid cells of a feature map to the different regions or windows. In certain cases, the different regions or windows of the feature map may be mutually exclusive (e.g., a grid cell may be assigned to only one region or window). In certain cases, the multi-view stage 503 may divide the feature map into multiple rows or columns of regions or windows. Some or all of the regions or windows may have the same (or different) sized (e.g., width and height), and one or more of the regions may overlap with multiple feature maps corresponding to different images. The rows of windows may be aligned or offset from each other.

As described herein, by using groups of grid cells (e.g., windows or subsets of images/feature maps) for comparison and enrichment (e.g., for self-attention) instead of an entire feature map or set of feature maps, the query analysis stage 506 may decrease processing demands and increase the speed and efficiency of processing the feature maps by the query analysis stage 506. These efficiencies can increase the rate at which the perception system 402 is able to accurately identify objects in the images 502.

The multi-view stage 503 may compare semantic data of groups of grid cells (e.g., different grid cells within a particular window or region) with each other. Based on the comparison, the multi-view stage 503 may modify the semantic data of the different grid cells. For example, the multi-view stage 503 may compare certain features of a grid cell (e.g., color, reflectivity, shape, etc.) with corresponding features of a different grid cell in the same group (e.g., compare features of a grid cell within window 552a with corresponding features of a different grid cell within the window 552a). Based on a similarity, the multi-view stage 503 may determine a probabilistic relationship between the grid cells in the group (e.g., probability that the grid cells are part of the same object, such as a vehicle, bicycle, pedestrian, construction cone, etc.). Based on this determination, the multi-view stage 503 may update one or more features of the grid cells. For example, one grid cell may be updated to indicate that it is the middle portion of an object and another grid cell may be updated to indicate that it is the beginning of the same object, etc.

In certain cases, the multi-view stage 503 may cross correlate some or all of the features of the various grid cells within a group (e.g., within a particular region) to each other. In this way, the multi-view stage 503 may enrich some or all of the grid cells within the particular group. Moreover, the multi-view stage 503 may repeat the comparison for each of the groups (e.g., windows) of a feature map and/or across some or all of the feature maps such that some or all grid cells of the feature maps are compared/updated based on comparisons with features from other grid cells in the same group (e.g., window or region).

As described above, with reference to the self-attention of object queries, in some cases, the multi-view stage 503 may generate a matrix that includes some or all of the grid cells within a group. The multi-view stage 503 may then determine a weight or probabilistic relationship between the grid cells and include the weight in the matrix. The multi-view stage 503 may use the weights/relationships in the matrix (indicative of a relationship or weight between grid cells) to calculate updated values for the features of the different grid cells. For example, the multi-view stage 503 may update a particular value of a particular grid cell using corresponding weighted values of some or all of the other grid cells in the group. An example of such a matrix and calculation (but for object queries) is described herein with reference to the self-attention of object queries. Moreover, this process may be repeated across some or all of the groups of grid cells of a feature map and across some or all of the feature maps. For example, the image feature extractor 504 may generate multiple feature maps for each image with each feature map corresponding to one or more detected characteristics of the image. In some such cases, the windows (or other form of grouping) may be applied to some or all of the feature maps and the grid cells of the feature maps updated as described herein.

In some cases, the query analysis stage 506 may include multiple layers of the multi-view stage 503. In some such cases, the groups (e.g., windows) in the different layers of the multi-view stage 503 may be different. In some cases, the windows may be sized and/or positioned differently.

### Object Query Formulation Stage

The object query formulation stage 505 (also referred to herein as the formulation stage 505) may be used to initialize, seed/modify, and/or enrich object queries. Accordingly, it will be understood that the formulation stage 505 may include one or more substages, including but not limited to an initialization stage, a seeding/modifying stage, and/or an enrichment stage.

In some cases, the formulation stage 505 may initiate a particular number of object queries. In certain cases, the formulation stage 505 initiates more object queries than a number of objects expected to be found in the image(s) 502. For example, if the formulation stage 505 expects there to be no more than 400 objects in a scene of the images 502, the formulation stage 505 may initiate some number greater than 400 object queries, such as 900 object queries.

The object queries may be organized as a vector or some other tensor shape and/or may include the same or a different number of features. For example, an object query may include 256 dimension features, or fewer or more dimension features. The features, alone or in combination, may represent one or more characteristics of an object, such as, but not limited to, its class, movement, relation to other objects, whether it is foreground or background, location, shape, size, color, texture, reflectivity, etc. In some cases, the formulation stage 505 may initiate the features of an object query randomly and/or pseudo-randomly. For example, the values for the features of the object queries may include random or pseudo-random numbers.

### Query Analysis Stage

Different layers of the query analysis stage 506 may include similar components. For example the query analysis stage 506 can include an object query self-attention stage 512, an object query cross-attention stage 514, and a feed forward network (FFN) stage 516. However, it will be understood that the query analysis stage 506 and/or different layers of the query analysis stage 506 may include different components. For example, the query analysis stage 506 and/or different layers of the query analysis stage 506 may include different components or different relationships between. In some cases, each layer of the query analysis stage 506 includes the same components in the same relationship. In certain cases, the layers of the query analysis stage 506 the components of the different layers may be configured differently or use different parameters. For example, the object query self-attention stage 512 of a first layer may use different parameters or configurations for processing the object queries than the object query self-attention stage 512 of a second layer. Similarly, different parameters may be used in different layers for the object query cross-attention stage 514, and/or the FFN stage 516, etc.

The components of a layer of the query analysis stage 506 may process data in parallel or sequentially. In some cases, the output of a stage within a layer may be used as the input to another stage within the layer. For example, the object query cross-attention stage 514 processes data output by the object query self-attention stage 512, and the FFN stage 516 processes data output by the object query cross-attention stage 514. However, it will be understood that the components of the query analysis stage 506 may be aligned in a variety of configurations.

The output of one layer of the query analysis stage 506 may be used as the input to a subsequent layer and the output of the last layer of the query analysis stage 506 may be provided to the detection stage 510. For example, in an N-layer query analysis stage 506, the output of the first layer may be used as the input of the second layer and so on until the output of the N−1 layer is used as the input of the Nth layer. After the Nth layer, the query analysis stage 506 can output enriched queries 614, which may be used as the input to the detection stage 510.

### Object Query Self-Attention Stage

The object query self-attention stage 512 may be configured to generate and/or enrich radar queries and object queries (e.g., using self-attention) using features from a group of queries.

As described herein, there may exist many radar queries and object queries and some or all of the queries may be modified by the object query cross-attention stage 514 (e.g., using grid cells from the feature maps). In some cases, the object query self-attention stage 512 may modify or enrich the object queries and radar queries by comparing the features of the queries with each other, determining a weighting value based on the comparison and modifying the features of the query using weighted features (weighted based on the determined weighting value). For example, the object query self-attention stage 512 may compare semantic data (or features) of an object query (or radar query) to determine a relationship between the object queries, such as a likelihood that the different object queries correspond to the same object or to different objects. In some cases, this may include comparing features of the object query that correspond to an object's class, movement, relation to other objects, whether it is foreground or background, color, light reflectivity, edge, texture, shape, etc. Based on the comparison, the object query self-attention stage 512 may update the object queries. In some cases, this may include modifying one or more values of a tensor corresponding to an object query.

In some cases, the object query self-attention stage 512 compares the features of a particular query (object or radar) with the features of some or all of the other queries (or some or all of the object features of a group of object features) to determine a correlation or similarity between the particular query and the other object queries. In some cases, the correlation or similarity can be represented as a probability or weight. Using the correlation between the particular object query and the other object or radar queries, the features of the queries (including the particular query) may be weighted and the weighted features may be used to calculate a new (or modified) value for the respective features of the particular query. For example, a first feature of some or all of the object queries may be weighted (relative to the particular object query) and the weighted values used to determine a value for the first feature of the particular object query. Similarly, the other features of the particular object or radar query may be updated (e.g., using the same or a different weighting). In some cases, the object query self-attention stage 512 may update the features of some or all of the object or radar queries in this way. In certain cases, the object query self-attention stage 512 may determine a matrix to indicate the relationship (or weight) between the features of the various object and radar queries and use the matrix to update the features of some or all of the object and radar queries.

### Object Query Cross-Attention Stage

The object query cross-attention stage 514 may be configured to enrich (a set of) object and radar queries (e.g., using cross-attention and/or using data from another stage, such as the object query self-attention stage 512 and/or the multi-view stage 503).

In some cases, the object query cross-attention stage 514 may enrich object and radar queries based on data received from the object query self-attention stage 512 and/or the multi-view stage 503. For example, the object query cross-attention stage 514 may use semantic data corresponding to one or more feature maps output by the multi-view stage 503 to modify or edit the object or radar query. In some cases, this may include modifying one or more features of a tensor corresponding to the object or radar query.

In some cases, the object query cross-attention stage 514 may correlate data from one or more feature maps enriched by the multi-view stage 503. As part of correlating the object query with one or more features maps, the object query cross-attention stage 514 may use one or more linear layers to identify one or more features in one or more feature maps. For example, the object query cross-attention stage 514 may multiply a tensor [1, N] corresponding to an object query by a learnable linear layer matrix [N, 2] to determine a location (x, y) in an (enriched) feature map that corresponds to a feature to be correlated with the object query.

The object query cross-attention stage 514 may use the features of the identified feature map to modify some or all of the features of the object or radar query. In some cases, this may include assigning a weight to a particular feature of the object or radar query and a weight to a corresponding feature of the identified feature map and using the result (non-limiting example: sum of the products) to modify or assign a new value to the particular feature of the object or radar query. In certain cases, the object query cross-attention stage 514 may use a learnable linear layer matrix to identify multiple features of one or more feature maps, and use the identified features to modify the features of the object query. In some such cases, the object query cross-attention stage 514 may assign different weights to the corresponding features of the different feature maps and use the weighted features to determine a corresponding feature of the object or radar query.

### Detection Stage

The detection stage 510 uses the output of the cross-attention stage 514 to determine bounding boxes for an enriched set of radar and object queries, and may be implemented using a detector, such as the CenterPoint Detector, an example of which is described in “Center-based 3D Object Detection and Tracking,” Yin et al., 6 Jan. 2021 (arXiv:2006.11275v2).

Fewer, more or different components may be used as part of the perception system 402. For example, in some cases, the perception system 402 may omit one or more layers of the query analysis stage 506. The enriched queries output by the query analysis stage 506 may be communicated to the detection stage 510 to generate bounding boxes 520. As another example, in certain cases, the multi-view stage 503 may be omitted or combined. For example, the feature maps generated by the lidar or image feature extractor 504 may be enriched in one or more layers during the multi-view stage 503.

Each stage, such as the self-attention stage 512, the cross-attention stage 514, and the FFN stage 516 may be followed by layer normalization processes. The normalization process can be a normalization process used in the art, such as batch normalization, weight normalization, layer normalization, group normalization, weight standardization or another normalization process.

As described herein, there may be multiple layers in the query analysis stage 506 for the object query cross-attention stage 514 and object query self-attention stage 512 such that enriched object queries 614 generated in a first layer of the query analysis stage 506 are communicated to a second layer (e.g., a second object query cross-attention stage 514 and/or second object query self-attention stage 512)

After the query analysis stage 506 finishes processing all of the layers, the output is a set of enriched queries. The set of enriched queries is machine representations (e.g., a 256 value vector) of the queries.

The detection stage 510 outputs bounding boxes 520 based on the enriched queries. The detection stage 510 can be a feed-forward network. In some embodiments, the FFN may predict coordinates, of a bounding box with respect to the input lidar or image, and predict the classification 522 associated with the bounding box.

Each query has a determined confidence value associated with each identified class. The FFN can use the class to determine the type of objects that are identified by a query. The FFN may have a defined number of detectable classes. For queries that identify an object within a class, the FFN may have a confidence threshold for determining whether to generate a bounding box associated with a specific query. The FFN may only use the highest confidence value of the class to determine whether to generate a bounding box. For example, the confidence threshold may be 0.5 and if the class with the greatest value does not satisfy the threshold, a bounding box would not be generated and the query would be discarded. The final output of the detection stage can be a defined encoding of a set of regression parameters representing the bounding box 520 and a classification 522 identifying the type of object.

In one embodiment, the bounding box is represented by an encoding of the set of parameters has the following parameters:

$$Regression parameters$$

$$0 , 1 , 2 = X , Y , Z coordinate of box centroid$$

$$3 , 4 , 5 = Width , length and height of the box$$

$$6 , 7 , 8 = Velocity X , Velocity Y , Velocity Z$$

$$9 , 10 , 11 = sin ( yaw\_orientation , cos ( yaw\_orientation ) , orientation bin$$

$$Class parameters$$

$$Number of classes ( 7 ) + background class ( 1 )$$

### Bounding Box Tracking Stage

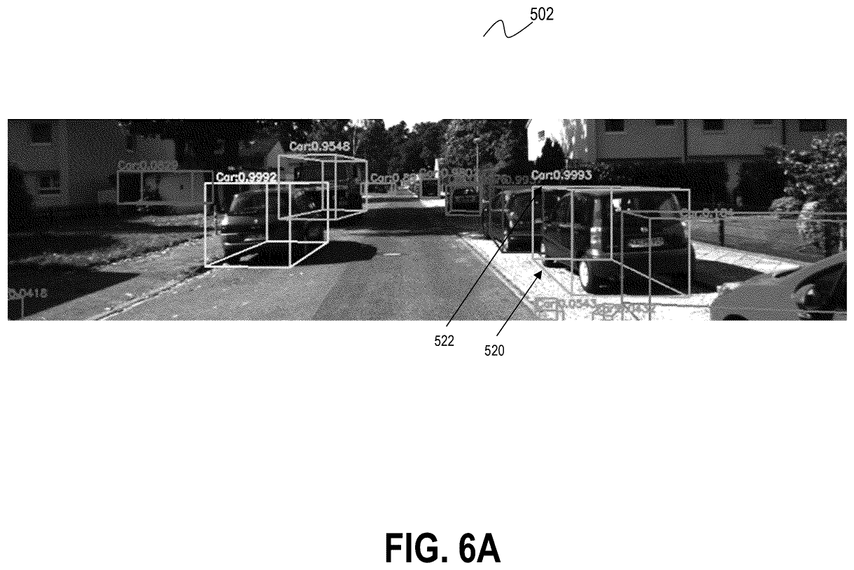

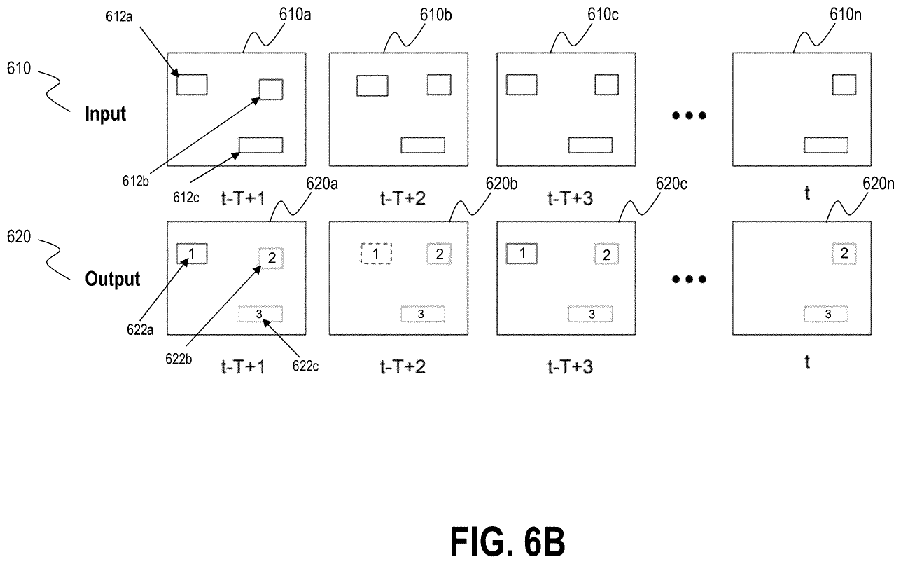

The bounding box tracking stage (BTS) 530 is described with additional reference to FIGS. 6A-6B, 7, and 8A-8B. FIG. 6A illustrates an example bounding boxes 520 and object classes 522 generated for a vehicle scene. The bounding boxes illustrated in FIG. 6A can be generated based on the processes described herein with respect to FIG. 5.

FIG. 6B illustrates a simplified example of a time series of bounding boxes generated based on image or lidar data at different time steps. Each input represents the bounding boxes generated at a different time step, t. The bounding boxes 612a-c are provided as input 610 for the bounding box tracking stage 530. The output 620 illustrates an example of identifiers 622a-c applied to bounding boxes 520 after processing during the BTS. In the illustrated example, the input data 610a associated with the scene at the defined time step, t−T+1. The input data 610a includes three bounding boxes 612a-c, which include a shape and position within the scene of the time step, t−T+1. At this time step the BTS determines a temporary unique identifier that is unique to the object for the duration that the object is identified within the scene data. This identifying data is identified in the output data 620a associated with the tracking of the bounding boxes. The output data of the BTS can include an output identifier 622, such as identifiers 622a-c. At subsequent time steps the BTS is configured to apply consistent numbering of the identifier associated with the object so that the object consistently is tracked by the perception system.

At subsequent time step, t−T+2, the system processes the input data 610b in order to assign identifiers to the bounding boxes present in the time step that correspond to the previously created identifiers in the previous time step t−T+1. The BTS can provide consistent identifiers for objects within the scene for the vehicle. For example, when the object from a scene is no longer present, the BTS can maintain consistent identifiers on the remaining objects within a scene. This can be used to differentiate the bounding boxes from each other and connect movement tacks between the bounding boxes. Additionally, the BTS can be used to identify and remove false positive bounding box detections. The false positive detection is illustrated in t−T+2 by the thick outlined bounding box. This bounding box was removed and replaced by the dashed box in the output 620b that corresponds to bounding box 612b and identifier 622b.

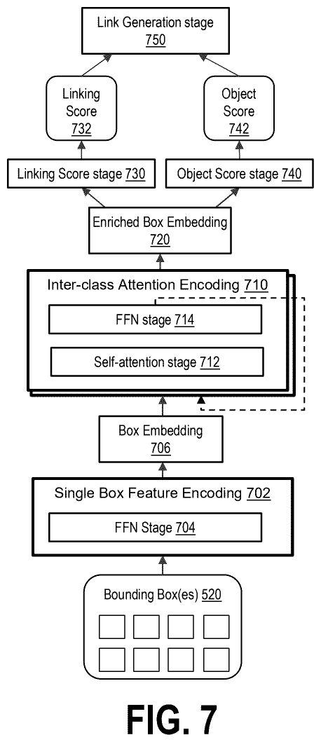

The generation of bounding box tracking data is described with further attention to FIG. 7. FIG. 7 is a data flow diagram illustrating an example perception environment 600 in which a perception system 402 generates tracking data associated with each bounding box 520. The bounding boxes 520 can be all of the bounding boxes generated during a time step. The time step can be over a defined period of time and including a set amount of data, such as 32 frames.

### Single Box Feature Encoding Stage

The single box feature encoding stage 702 can generate bounding box embeddings 706 for each bounding box 520 received as input at each time step. The input to 702 includes the raw 3D box information such as center position xyz, box width, length, height, sine and cosine of heading angle, time, detection confidence scores, etc. It will be understood that the single box feature encoding stage 702 may include one or more substages, including but not limited to an feed forward network (FFN) stage 704.

The single box feature encoding stage 702 can generate the bounding box embeddings 706 (also referred to herein as box embeddings) based on the bounding boxes 520 received as input. At each time step, a different number of bounding boxes 520 may be generated by the perception system 402. For each bounding box 520 generated, the single box feature encoding stage 702 may generate a corresponding bounding box embedding 706. The bounding box embedding 706 can be generated using a feed forward network. The embedding may be calculated using various methodologies, such as MLP layer embedding. For example, the MLP layer embedding can be a 2 layer embedding, such as a linear layer and a Relu layer, that is used to transform the bounding box from a first dimension to a second dimension. The shape and position data of the bounding box can be transformed to a machine understandable embedding. For example, the raw input feature of the bounding box information can be a 20 dimension vector and can be transformed to a 512 dimension vector.

The single box feature encoding stage 702 generates a set number of embeddings based on the number of bounding boxes 520 received. Each box embedding 706 is then output to the inter-box attention encoding stage 710.

### Inter-Box Attention Encoding Stage

The inter-box attention encoding stage 710 may be used to enrich the bounding box embeddings using self-attention techniques. This stage uses self-attention from transformer to exchange information among all the box embeddings output from 702. In the illustrated example, the inter-box attention encoding stage 710 includes one or more blocks of a self-attention stage 712 and a FFN stage 714. In the illustrated example of FIG. 7, a block of the inter-box attention encoding stage 710 includes a self-attention stage 712 and a feed forward network (FFN) stage 714. However, it will be understood that the inter-box attention encoding stage 710 and/or different layers of the inter-box attention encoding stage 710 may include different components. For example, the inter-box attention encoding stage 710 and/or different layers of the inter-box attention encoding stage 710 the inter-box attention encoding stage 710 may include different components or different relationships between. In some cases, each layer of the inter-box attention encoding stage 710 includes the same components in the same relationship. In certain cases, the block of the inter-box attention encoding stage 710 the components of the different blocks may be configured differently or use different parameters. For example, the self-attention stage 712 of a first layer may use different parameters or configurations for processing the box embeddings than the self-attention stage 712 of a second layer. Similarly, different parameters may be used in different layers for the FFN stage 714.

The components of a layer of the inter-box attention encoding stage 710 may process data in parallel or sequentially. In some cases, the output of a stage within a layer may be used as the input to another stage within the layer. For example, in the illustrated example of FIG. 7, the FFN stage 714 processes data output by the self-attention stage 712. However, it will be understood that the components of the inter-box attention encoding stage 710 may be aligned in a variety of configurations.

The output of one block of the inter-box attention encoding stage 710 may be used as the input to a subsequent block. For example, in an N-block inter-box attention encoding stage 710, the output of the first block may be used as the input of the second block and so on until the output of the N−1 block is used as the input of the Nth block. After the Nth block, the inter-box attention encoding stage 710 can output enriched box embeddings 720, which may be used as the input to the linking score stage 730 and/or the object score stage 740.

Inter-box attention encoding stage 710 uses self-attention and FFN to learn a robust box embedding by encoding spatial-temporal box distribution to each individual enriched box embedding from all the box embeddings 706.

### Self-Attention Stage

The self-attention stage 712 may be configured to generate and/or enrich box embeddings 706 (e.g., using self-attention) using features from a group of box embeddings.

As described herein, there may exist many box embeddings and some or all of them may be modified by the self-attention stage 712. In some cases, the self-attention stage 712 may modify or enrich the box embeddings 706 by comparing the features of the individual box embeddings with each other, determining a weighting value based on the comparison and modifying the features of the box embedding using weighted features (weighted based on the determined weighting value). For example, the self-attention stage 712 may compare semantic data (or features) of a box embedding to determine a relationship between the box embeddings, such as a relationship between the positions of the different box embeddings. In some cases, the self-attention can be global self-attention for all bounding boxes within the time step. In some cases the self-attention can be local where the self-attention applies locally to nearby objects and gradually encodes more global information. In some cases, this may include comparing features of the object query that correspond to an object's class, movement, dimension, heading angle, box-to-box topological structure, relation to other objects. Based on the comparison, the self-attention stage 712 may update the box embeddings. In some cases, this may include modifying one or more values of a tensor corresponding to the box embedding.

In some cases, the self-attention stage 712 compares the features of a particular box embedding with the features of some or all of the other box embedding to determine a correlation or similarity between the particular box embedding and the other box embeddings. In some cases, the correlation or similarity can be represented as a probability or weight. Using the correlation between the particular box embedding and the other box embeddings, the features of the box embedding (including the particular box embedding) may be weighted and the weighted features may be used to calculate a new (or modified) value for the respective features of the particular box embedding. The self-attention stage 712 can encode spatial-temporal context information, such as the topology graph information of each box with respect to nearby boxes, leading to a robust box representation for bounding box tracking. For example, a first feature of some or all of the object queries may be weighted (relative to the particular box embedding) and the weighted values used to determine a value for the first feature of the particular box embedding. Similarly, the other features of the particular box embedding may be updated (e.g., using the same or a different weighting). In some cases, the self-attention stage 712 may update the features of some or all of the box embeddings in this way. In certain cases, the self-attention stage 712 may determine a matrix to indicate the relationship (or weight) between the features of the various box embeddings and use the matrix to update the features of some or all of the box embeddings.

As a non-limiting example, consider the following three box embeddings and values for their features: Box Embedding 1 [1,4]=(0.2, 0.2, 0.4, 0.7); Box Embedding 2 [1,4]=(0.3, 0.4, 0.6, 0.7); Box Embedding 3 [1,4]=(0.1, 0.8, 0.9, 0.7).

After analyzing the features of the three box embeddings, assume that the self-attention stage 712 generates the following relationship (or weighting) matrix between them:

| | Box | Box | Box |
|---|---|---|---|
| | Embedding 1 | Embedding 2 | Embedding 3 |
| Box Embedding 1 | .7 | .2 | .1 |
| Box Embedding 2 | .2 | .6 | .2 |
| Box Embedding 3 | .1 | .2 | .7 |

Based on the determined relationship or weighting, the self-attention stage 712 may update the values for the features of the box embeddings as follows:

Box Embedding 1 [1,4]=(0.21, 0.3, 0.49, 0.7) or (0.7*0.2+0.2*0.3+0.1*0.1, 0.7*0.2+0.2*0.4+0.1*0.8, 0.7*0.4+0.2*0.6+0.1*0.9, 0.7*0.7+0.7*0.2+0.7*0.1).

Box Embedding 2 [1,4]=(0.24, 0.44, 0.62, 0.7) or (0.2*0.2+0.6*0.3+0.2*0.1, 0.2*0.2+0.6*0.4+0.2*0.8, 0.2*0.4+0.6*0.6+0.2*0.9, 0.2*0.7+0.6*0.7+0.2*0.7.

Box Embedding 3 [1,4]=(0.15, 0.66, 0.79, 0.7) or (0.1*0.2+0.2*0.3+0.7*0.1, 0.1*0.2+0.2*0.4+0.7*0.8, 0.1*0.4+0.2*0.6+0.7*0.9, 0.1*0.7+0.2*0.7+0.7*0.7

### FFN Stage

After the self-attention stage 712, the FFN stage 714 may transform the box embeddings 706 to a defined dimensional output. The FFN stage can converge the output of the self-attention stage 712 to a vector having a defined format, such as a 512 dimension vector. The FFN stage 714 can converge the vector to a lower space embedding. The output of the FFN stage 714 can be provided to the next block of the inter-box attention encoding for processing until the total number of blocks has been completed.

### Enriched Box Embedding

The output of one block of the inter-box attention encoding stage 710 may be used as the input to a subsequent block and the output of the last block of the inter-box attention encoding stage 710 may be provided to the detection stage 510. For example, in an N-layer decoder stage 710, the output of the first layer may be used as the input of the second layer and so on until the output of the N−1 layer is used as the input of the Nth layer. After the Nth layer, the decoder stage 710 can output enriched box embeddings 720, which may be used as the input to the linking score stage 730 and/or the object score stage 740. The enriched box embedding 720 can have the same defined dimensional structure as the input box embedding 706.

### Linking Score Stage

At the linking score stage 730, linking scores 732 can be generated. The linking score stage may include multiple processing layers to generate the linking score. The linking score may be calculated using various methodologies. In some cases, the linking score stage 730 may include a feed forward network, such as an MLP, for further processing the enriched bounding box embedding 720. The MLP layer may be followed by a dot product of the resulting embedding output from the MLP. The dot-product can provide a correlation between pairs of the enriched box embeddings 720. The linking score stage can generate the box-to-box linking scores 732, which can describe confidence scores of whether two boxes should be linked. The box-to-box linking scores can result in an individual linking score for each box pair. In some cases, the score values can range from 0 to 1. The linking score 732 can be used to create tracks from the detected boxes during the track generation stage 750.

### Object Score Stage

At the object score stage 740, object scores 742 can be generated. The object score stage may include multiple processing layers to generate the object score. The object score may be calculated using various methodologies. In some cases, the object score stage 740 may include a feed forward network, such as an MLP, for further processing the enriched bounding box embedding 720. The MLP layer may provide a regression output for each box. The object score stage 740 can generate object score 742. The object score 742 can be used to determine whether each bounding box is from a real object or a false positive detected box. The object score 742 can be used to remove bounding boxes that are determined to be falsely detected during the track generation stage 750.

### Track Generation Stage

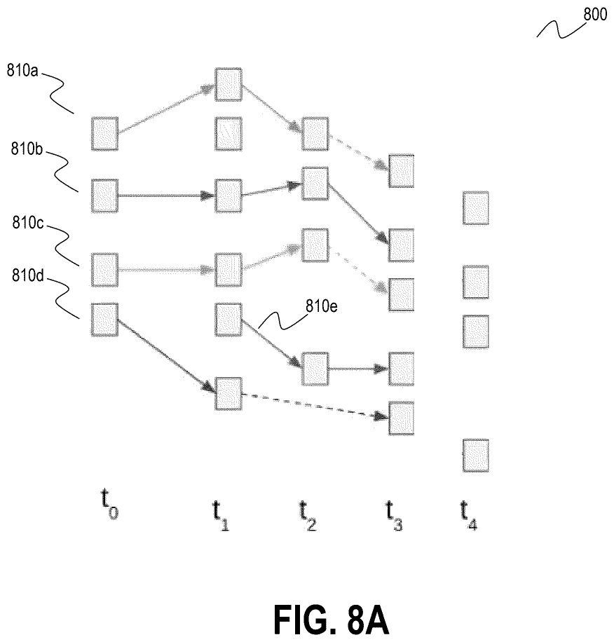

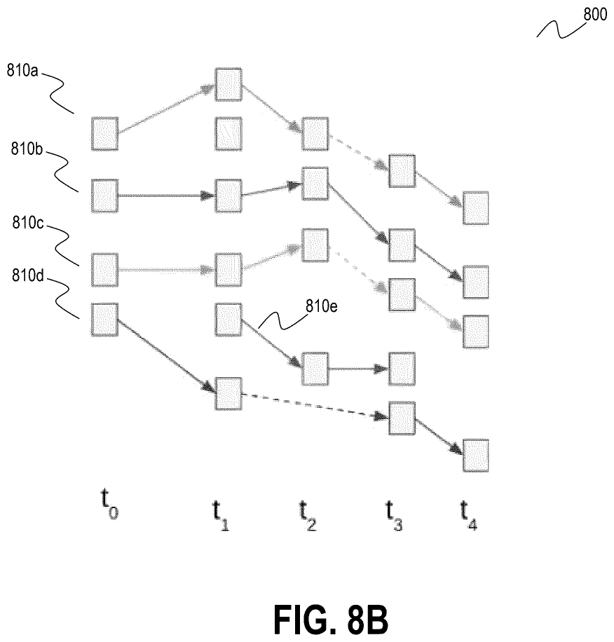

At the track generation stage 750, links between bounding boxes can be generated to form tracks. The track generation stage 750 will be described with additional reference to FIGS. 8A-8B, which illustrate examples of the linking process between bounding boxes at different time steps. FIGS. 8A-8B illustrate examples bounding boxes generated in subsequent time steps based on lidar or image data at the bounding box tracking stage 530. FIG. 8A illustrates a visual example of a plurality of tracks 800 including a number of tracks 810a-e within a track list. New bounding boxes that have not been added to the tracks are added at t₄. In FIG. 8B links between the existing tracks and the bounding boxes are formed.

During initialization of the track generation stage, a track list of bounding boxes is generated. The track list includes a list of object tracks. Each track includes the bounding boxes corresponding to the same object over time. Each bounding box is associated with a different track and assigned a corresponding identifier. The bounding box data associated with the track list can include spatial and positional data associated with the bounding box, such as, for example, xyz coordinates, width, length, heading angle, and classification scores.

After initialization, the linking scores and object scores for subsequent are used to determine linkings between the bounding boxes from the latest time frame and the bounding boxes within the track list from a previous time frame. The object scores 742 can be used to remove bounding boxes that have been falsely detected. Bounding boxes associated with object scores that are less than a threshold can be removed prior to determining linkings between bounding boxes and tracks.

In online tracking mode, the linking scores 732 include box-to-box linking scores that can be used to match a bounding box with a track from the track list. The system compares the linking scores of the boxes to generate matches with boxes from the track list. In some cases, Hungarian matching can be applied to associate tracks with bounding boxes. The match of a bounding box to a track is the linking score with the linking score that has the maximal box-to-box value between the bounding box and the tracked box. Additional constraints can be added to avoid matching a track with a box from a different classification of bounding box. For example, preventing a pedestrian from being matched with a vehicle track. Additional distance constraints can be added to avoid matching a track' tail box to a box with center distance that is larger than the maximal possible speed times the time difference. For each matched detection, the bounding box associated with the linking score is appended to the matched track as the tail box. For each unmatched bounding box, generate a new track with a new identifier with unconfirmed status corresponding to the unmatched bounding box. A new track status is changed to confirm if it has accumulated certain boxes, for example two boxes. For tracks within the track list that do not have any newly matched bounding box detections for a defined period of time (e.g., two seconds, or any other time period), remove the track from the track list.

Offline tracking can be used in offline perception systems to auto-label drive logs, for example, provide tracking identities to each bounding box detected by offline lidar or image based object detectors. In offline tracking, linking scores for all the frames can be generated before the link generation. Then Non-maximum suppression strategy can be used to link boxes in consecutive frames from highest linking scores to lowest linking scores. If a link between box i and box j has already been selected in a link with higher linking score, all other links connected to box i or box j from the same two frames will be suppressed or pruned. After the non-maximum suppression, a set of short tracks are linked from boxes. In some cases, tracks can be stitched together. If two tracks have no overlapping and the linking score between the two tracks is above a threshold, the tracks can be combined into a single track. The track to track stitching score could be computed as the linking score between the tail box of one track and the head box of another track. In some cases, missing boxes between tracks may be interpolated for intermediate time frames.

### Bounding Box Score Formulation

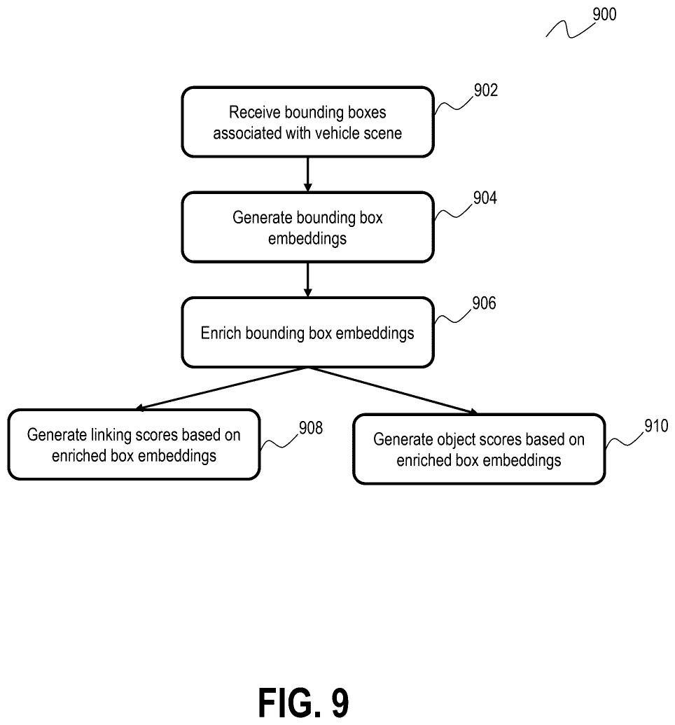

FIG. 9 is a flow diagram illustrating an example of a routine 900 implemented by at least one processor to generate bounding box tracking scores during operation of an autonomous vehicle. The flow diagram illustrated in FIG. 9 is provided for illustrative purposes only. It will be understood that one or more of the steps of the routine illustrated in FIG. 9 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components and/or the autonomous vehicle compute 400 may be used.

At block 902, the perception system 402 receives bounding boxes associated with a vehicle scene. As described herein, the bounding boxes may be generated from one or more images. The bounding boxes for a time frame may be generated based on object queries associated with the vehicle scene. The bounding box can be a defined encoding of a set of regression parameters representing the bounding box and a classification identifying the type of object. For example, the bounding box data can include spatial and positional data associated with the bounding box.

At block 904, the perception system 402 generates at least one bounding box embedding based on the bounding box(es). As described herein, at each time step, a different number of bounding boxes 520 may be generated by the perception system 402. For each bounding box 520 generated, the perception system 402 may generate a corresponding bounding box embedding 706. The bounding box embedding 706 can be generated using a feed forward network from the raw bounding boxes 520. The embedding may be calculated using various methodologies, such as MLP layer embedding. For example, the MLP layer embedding can be a 2 layer embedding, such as a linear layer and a Relu layer, that is used to transform the bounding box from a first dimension to a second dimension. The position, dimension, heading angle, classification scores data of the bounding box can be transformed to a machine understandable embedding. The perception system 402 may then output the bounding box embeddings.

At block 906, the perception system 402 enriches the bounding box embeddings. As described herein, the perception system 402 may enrich the bounding box embeddings using self-attention techniques. The perception system may use a inter-box attention encoding including one or more blocks of a self-attention stage 712 and an FFN stage 714. Different layers of the inter-box attention encoding stage 706 may include similar components. In the illustrated example of FIG. 7, a layer of the decoder stage 710 includes a self-attention stage 712 and a feed forward network (FFN) stage 714.

The self-attention stage 712 may modify or enrich the box embeddings 706 by comparing the features of the individual box embeddings with each other, determining a weighting value based on the comparison and modifying the features of the box embedding using weighted features (weighted based on the determined weighting value). For example, the self-attention stage 712 may compare semantic data (or features) of a box embedding to determine a relationship between the box embeddings, such as a relationship between the positions of the different box embeddings. In some cases, the self-attention can be global self-attention for all bounding boxes within the time window. In some cases the self-attention can be local where the self-attention applies locally to nearby objects and gradually encodes more global information. Based on the comparison, the self-attention stage 712 may update the box embeddings.

The FFN may transform the box embeddings 706 to a defined dimensional output. The FFN stage can converge the output of the self-attention stage 712 to a vector having a defined format, such as a 512 dimension vector.

At block 908, the perception system 402 generates linking scores based on bounding box embeddings. The linking score stage may include multiple processing layers to generate the linking score. The linking score may be calculated using various methodologies. In some cases, the linking score stage 730 may include a feed forward network, such as an MLP, for further processing the enriched bounding box embedding 720. The MLP layer may be followed by a dot product of the resulting embedding output from the MLP. The dot-product can provide a correlation between pairs of the enriched box embeddings 720. The linking score stage can generate the box-to-box linking scores 732, which can describe confidence scores of whether two boxes should be linked. The box-to-box linking scores can result in an individual linking score for each box pair.

At block 910, the perception system 402 generates object scores based on bounding box embeddings. The object score stage may include multiple processing layers to generate the object score. The object score may be calculated using various methodologies. In some cases, the object score stage 740 may include a feed forward network, such as an MLP, for further processing the enriched bounding box embedding 720. The MLP layer may provide a regression output for each box. The object score stage 740 can generate object score 742. The object score 742 can be used to determine whether each bounding box is from a real object or a false positive detected box.

### Navigation Using Bounding Boxes Tracking

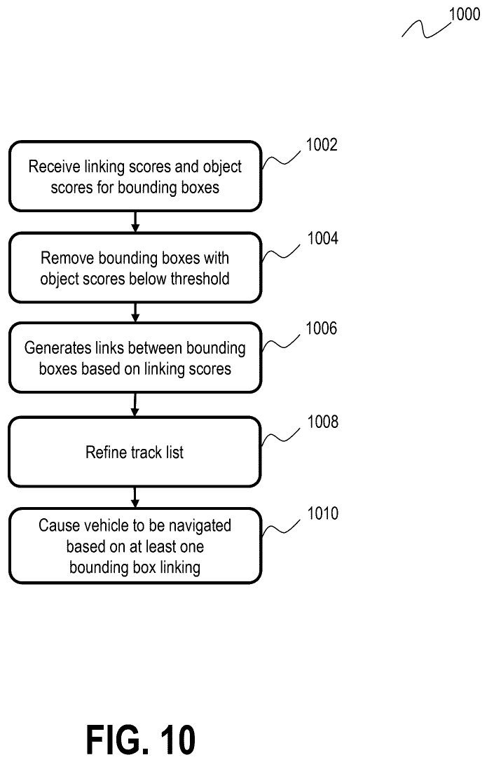

FIG. 10 is a flow diagram illustrating an example of a routine 1000 implemented by at least one processor to navigate a vehicle based on bounding box tracking of at least one bounding box generated from one or more point clouds or images. The flow diagram illustrated in FIG. 10 is provided for illustrative purposes only. It will be understood that one or more of the steps of the routine illustrated in FIG. 10 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components and/or the autonomous vehicle compute 400 may be used.

At block 1002, the perception system 402 receives linking scores and object scores for the bounding boxes. The linking scores and object scores can be received on a rolling basis for a time frame. The perception system 402 can use the linking scores and object scores to initialize and/or update a track list for tracking bounding boxes within the vehicle scene.

At block 1004, the perception system 402 removes bounding boxes with object scores below a threshold. As described herein, the object scores 742 can be used to remove bounding boxes that have been falsely detected. Bounding boxes associated with object scores that are less than a threshold can be removed prior to determining linkings between bounding boxes and tracks.

At block 1006, the perception system 402 generates links between bounding boxes based on linking scores. As described herein, the linking scores 732 include box-to-box linking scores that can be used to match a bounding box with a track from the track list. The system compares the linking scores of the boxes to generate matches with boxes from the track list. In some cases, Hungarian matching can be applied to associate tracks with bounding boxes. The match of a bounding box to a track is the linking score with the linking score that has the maximal box-to-box value between the bounding box and the tracked box. Additional constraints can be added to avoid matching a track with a box from a different classification of bounding box. For example, preventing a pedestrian from being matched with a vehicle track. Additional distance constraints can be added to avoid matching a track' tail box to a box with center distance that is larger than the maximal possible speed times the time difference.

At block 1008, in online tracking, for each matched detection, the bounding box associated with the linking score is appended to the matched track as the tail box. For each unmatched bounding box, generate a new track with a new identifier corresponding to the unmatched bounding box. For tracks within the track list that do not have any confirmed bounding box detections for a defined period of time (e.g., two seconds, or any other time period), they may be removed from the track list.

Counterpart to block 1008, in offline tracking, linking scores for all the frames can be generated before the track generation. Then Non-maximum suppression strategy can be used to link boxes in consecutive frames from highest linking scores to lowest linking scores. If a link between box i and box j has already been selected in a link with higher linking score, all other links connected to box i or box j from the same two frames will be suppressed or pruned. After the non-maximum suppression, a set of short tracks are linked from boxes. In some cases, tracks can be stitched together. If two tracks have no overlapping and the linking score between the two tracks is above a threshold, the tracks can be combined into a single track.

At block 1010, the perception system 402 causes the vehicle to be navigated based on the at least one bounding box linking. In some cases, the perception system 402 may communicate the bounding boxes linking and track list to the planning system 404. The planning system 404 may use the bounding boxes to determine how to navigate a vehicle scene.

Fewer, more, or different blocks can be used with routine 1000. In some cases, any one or any combination of blocks from routine 900 may be combined with blocks from routine 1000 or vice versa.

### EXAMPLES

Various example embodiments of the disclosure can be described by the following clauses:

Clause 1. A method, comprising: generating a first set of bounding boxes in a scene of a vehicle at a first time step based on image data associated with at least one sensor; generating a first set of bounding box embeddings based on the first set of bounding boxes, wherein each bounding box embedding corresponds to a different bounding box of the first set of bounding boxes; enriching the first set of bounding box embeddings to generate a first set of enriched bounding box embeddings; generating at least one linking score for each bounding box based on the first set of enriched bounding box embeddings; generating links between individual bounding boxes of the first set of bounding boxes and individual bounding box tracks of a plurality of bounding box tracks based on the at least one linking score, wherein each bounding box track of the plurality of bounding box tracks is associated with a bounding box generated at a previous time step; and causing the vehicle to be controlled based on at least one of the bounding box links.

Clause 2. The method of clause 1, wherein generating an object score using a multilayer perceptron.

Clause 3. The method of clause 2 further comprising removing bounding boxes from the first set of bounding boxes when the object score does not satisfy an object score threshold.

Clause 4. The method of any of clauses 1-3, wherein enriching the first set of bounding box embeddings comprises performing attention computing functions between the first set of bounding box embeddings.

Clause 5. The method of any of clauses 1-4, wherein generating the at least one linking score is based on at least one of a regressive multilayer perceptron or a dot product operation.

Clause 6. The method of clause 5, wherein generating the at least one linking score comprises generating a box-to-box linking score for each pair of bounding box embeddings of the first set of bounding box embeddings.

Clause 7. The method of any of clauses 1-6 further comprising generating a bounding box track for bounding boxes that are not linked to an existing bounding box track.

Clause 8. The method of any of clauses 1-7 further comprising removing bounding box tracks from the plurality of bounding box tracks after a threshold amount of time has passed.

Clause 9. The method of any of clauses 1-8, wherein each bounding box track is associated with a unique identifier.

Clause 10. The method of any of clauses 1-9 further comprises verifying a classification type of the bounding box matches a classification type of the bounding box track and verifying a center distance of two boxes falls within valid range, before linking a bounding box to a bounding box track

Clause 11. The method of any of clauses 1-10 further comprises generating offline tracks with linking scores and object scores.

Clause 12. A system, comprising: a data store storing computer-executable instructions; and a processor configured to execute the computer-executable instructions, wherein execution of the computer-executable instructions causes the system to: generate a first set of bounding boxes in a scene of a vehicle at a first time step based on image data associated with at least one sensor; generate a first set of bounding box embeddings based on the first set of bounding boxes, wherein each bounding box embedding corresponds to a different bounding box of the first set of bounding boxes; enrich the first set of bounding box embeddings to generate a first set of enriched bounding box embeddings; generate at least one linking score for each bounding box based on the first set of enriched bounding box embeddings; generate links between individual bounding boxes of the first set of bounding boxes and individual bounding box tracks of a plurality of bounding box tracks based on the at least one linking score, wherein each bounding box track of the plurality of bounding box tracks is associated with a bounding box generated at a previous time step; and cause the vehicle to be controlled based on at least one of the bounding box links.

Clause 13. The system of clause 12, wherein to generate an object score the processor is further configured to use a multilayer perceptron.

Clause 14. The system of clause 13 wherein the processor is further configured to remove bounding boxes from the first set of bounding boxes when the object score does not satisfy an object score threshold.

Clause 15. The system of any of clauses 12-14, wherein to enrich the bounding box embeddings the processor is further configured to perform computing functions between the first set of bounding box embeddings.

Clause 16. The system of any of clauses 12-15, wherein the generation of the at least one linking score is based on at least one of a regressive multilayer perceptron or a dot product operation.

Clause 17. The system of clause 16, wherein to generate the at least one linking score the processor is further configured to generate a box-to-box linking score for each pair of bounding box embeddings of the first set of bounding box embeddings.

Clause 18. The system of any of clauses 12-17, wherein the processor is further configured to generate a bounding box track for bounding boxes that are not linked to an existing bounding box track.

Clause 19. The system of any of clauses 12-18, wherein the processor is further configured to remove bounding box tracks from the plurality of bounding box tracks after a threshold amount of time has passed.

Clause 20. The system of any of clauses 12-19, wherein each bounding box track is associated with a unique identifier.

Clause 21. The system of any of clauses 12-20 further comprises generating offline tracks with linking scores and object scores.

Clause 22. The system of any of clauses 12-21, wherein the processor is further configured to verify a classification type of the bounding box matches a classification type of the bounding box track, and verify a center distance of two boxes falls within valid range track, before linking a bounding box to a bounding box track.

### Additional Examples

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously recited step or entity.

1. A method, comprising:
generating a first set of bounding boxes in a scene of a vehicle at a first time step based on image data associated with at least one sensor;
generating a first set of bounding box embeddings based on the first set of bounding boxes, wherein each bounding box embedding corresponds to a different bounding box of the first set of bounding boxes;
enriching the first set of bounding box embeddings to generate a first set of enriched bounding box embeddings;
generating at least one linking score for each bounding box based on the first set of enriched bounding box embeddings;
generating links between individual bounding boxes of the first set of bounding boxes and individual bounding box tracks of a plurality of bounding box tracks based on the at least one linking score, wherein each bounding box track of the plurality of bounding box tracks is associated with a bounding box generated at a previous time step; and
causing the vehicle to be controlled based on at least one of the bounding box links.

2. The method of claim 1, wherein generating an object score comprises using a multilayer perceptron.

3. The method of claim 2 further comprising removing bounding boxes from the first set of bounding boxes when the object score does not satisfy an object score threshold.

4. The method of claim 1, wherein enriching the first set of bounding box embeddings comprises performing inter-box attention encoding computing functions between the first set of bounding box embeddings.

5. The method of claim 1, wherein generating the at least one linking score is based on at least one of a regressive multilayer perceptron or a dot product operation.

6. The method of claim 5, wherein generating the at least one linking score comprises generating a box-to-box linking score for each pair of bounding box embeddings of the first set of bounding box embeddings.

7. The method of claim 1 further comprising generating a bounding box track for bounding boxes that are not linked to an existing bounding box track.

8. The method of claim 1 further comprising removing bounding box tracks from the plurality of bounding box tracks after a threshold amount of time has passed.

9. The method of claim 1, wherein each bounding box track is associated with a unique identifier.

10. The method of claim 1 further comprises verifying a classification type of the bounding box matches a classification type of the bounding box track and verifying a center distance of two boxes falls within valid range, before linking a bounding box to a bounding box track.

11. The method of claim 1 further comprises generating offline tracks with linking scores and object scores.

12. A system, comprising:
a data store storing computer-executable instructions; and
a processor configured to execute the computer-executable instructions, wherein execution of the computer-executable instructions causes the system to:
generate a first set of bounding boxes in a scene of a vehicle at a first time step based on image data associated with at least one sensor;
generate a first set of bounding box embeddings based on the first set of bounding boxes, wherein each bounding box embedding corresponds to a different bounding box of the first set of bounding boxes;
enrich the first set of bounding box embeddings to generate a first set of enriched bounding box embeddings;
generate at least one linking score for each bounding box based on the first set of enriched bounding box embeddings;
generate links between individual bounding boxes of the first set of bounding boxes and individual bounding box tracks of a plurality of bounding box tracks based on the at least one linking score, wherein each bounding box track of the plurality of bounding box tracks is associated with a bounding box generated at a previous time step; and
cause the vehicle to be controlled based on at least one of the bounding box links.

13. The system of claim 12, wherein to generate an object score the processor is further configured to use a multilayer perceptron.

14. The system of claim 13 wherein the processor is further configured to remove bounding boxes from the first set of bounding boxes when the object score does not satisfy an object score threshold.

15. The system of claim 12, wherein to enrich the bounding box embeddings the processor is further configured to perform inter-box attention embedding computing functions between the first set of bounding box embeddings.

16. The system of claim 12, wherein the generation of the at least one linking score is based on at least one of a regressive multilayer perceptron or a dot product operation.

17. The system of claim 16, wherein to generate the at least one linking score the processor is further configured to generate a box-to-box linking score for each pair of bounding box embeddings of the first set of bounding box embeddings.

18. The system of claim 12, wherein the processor is further configured to generate a bounding box track for bounding boxes that are not linked to an existing bounding box track.

19. The system of claim 12, wherein the processor is further configured to remove bounding box tracks from the plurality of bounding box tracks after a threshold amount of time has passed.

20. The system of claim 12, wherein each bounding box track is associated with a unique identifier.

21. The system of claim 12 further comprises generating offline tracks with linking scores and object scores.

22. The system of claim 12, wherein the processor is further configured to verify a classification type of the bounding box matches a classification type of the bounding box track, and verify a center distance of two boxes falls within valid range track, before linking a bounding box to a bounding box track.
